(19) United States
(12) Patent Application Publication
(10) Pub. No.: US 2009/0132632 A1
(43) Pub. Date: May 21, 2009

(54) Accessing Communication History Using Identification Information from Received Communication

(75) Inventors: James Jackson, Austin, TX (US); Bernard Ku, Austin, TX (US); Mehrad Yasrebi, Austin, TX (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 11/941,346

(22) Filed: Nov. 16, 2007

(51) Int. Cl. G06F 15/16; G06F 7/06; G06F 3/048

(52) U.S. Cl. 709/201; 707/3; 715/846; 707/E17.014

(57) ABSTRACT

The communication history associated with a contacting party is accessed using identification information provided with an incoming communication. The incoming communication may have a different service type (e.g., email, telephone call, instant message chat) compared to stored communications that make up the communication history for a contacting party. Multiple uniform resource identifiers may be accessed upon processing of identification information associated with the contacting party's incoming communication. Communication histories associated with each uniform resource identifier may be accessed and combined to provide a party receiving the communication with a complete communication history including stored communications having differing service types.

### BACKGROUND

1. Field of the Disclosure

The present disclosure generally relates to converged multimedia services, and more specifically, to accessing a communication history using identification information from one or more received communications.

2. Description of the Related Art

Organizations with a large customer base often operate call centers for receiving customer calls. In some cases, customers call or otherwise contact an organization repeatedly to discuss a particular account or problem.

### BRIEF DESCRIPTION OF THE DRAWINGS

FIG. 1 illustrates a network that may be used in setting up a communication session such as a telephone call during operation of one or more disclosed embodiments;

FIG. 2 illustrates a methodology for conducting database queries during set up of a communication session between session initiation protocol (SIP) enabled appliances;

FIG. 3 illustrates a system architecture and other aspects for receiving identification information from a received communication and mapping the information or a converted form of the information into multiple uniform resource identifiers (URIs) that may relate to different service types such as email and instant message (IM) chats;

FIG. 4 depicts a service application receiving identification information and accessing multiple URIs from a server, with the server conducting one or more queries based on an E.164 compliant string derived from the identification information;

FIG. 5 depicts conversion of telephone number mapping protocol records into entries in a relational database;

FIG. 6 illustrates using identification information from communications from different service types (e.g., email and instant messaging) to derive multiple URIs from a portion of a database; and

FIG. 7 is an example graphical user interface for providing access to the communication history for a calling party, wherein communications that make up the history may have occurred using differing service types (e.g., email, telephone call, instant message chats).

### DESCRIPTION OF THE EMBODIMENT(S)

In one aspect, a method is disclosed that includes receiving an originating communication that includes identification data of the sender. The method further includes querying a database for multiple URIs. Each URI has an element associated with the identification database. Each URI is associated with at least one service type chosen from a plurality of service types. At least one of the plurality of service types differs from at least one other of the plurality of service types. The method further includes receiving one or more records corresponding to each URI. In some embodiments, at least one of the plurality of service types is a telephone number, an email address, a mobile telephone address, an SIP telephone address, or an IM contact address. The database may be a tElephone NUmber Mapping (ENUM) database. The identification data may include a telephone number, and the method may further comprise converting the telephone number into a Fully Qualified Domain Name (FQDN), e.g., 5.8.4.5.2.7.3.5.5.5.1.e164.arpa. The identification data may include an email address or an IM chat name. The method may further include presenting a graphical user interface including selectable icons for accessing data from each of the one or more records corresponding to each URI.

In another aspect, a data processing system is disclosed that includes a client application stored on a computer readable medium. The client application has instructions operable for receiving identification data associated with an incoming communication. The client application further has instructions operable for receiving a first URI corresponding to the identification data. Further, the client application has instructions operable for receiving a second URI corresponding to the identification data. The first URI has a first service type and the second URI has a second service type that is different from the first service type. The client application further has instructions operable for receiving a first communication history for the first URI and receiving a second communication history for the second URI. There may be third, fourth, fifth and more URIs.

In addition, service for providing a communication history related to a contacting party is disclosed. The service comprises receiving identification data from a communication received from the contacting party. The service further comprises accessing multiple URIs, wherein at least one URI corresponds to the identification data or may be derived using the identification data. The service further comprises accessing a saved communication for each of the multiple URIs that are accessed. A first service type associated with a first saved communication differs from a second service type of another of the saved communications.

In the following description, for the purposes of explanation, numerous specific details are set forth in order to provide a thorough understanding of the disclosed embodiments. A person of ordinary skill in the art should recognize that embodiments might be practiced without some of these specific details. In other instances, well-known structures and devices may be shown in block diagram form or omitted for clarity.

Disclosed embodiments provide a dynamic mechanism for providing converged multimedia communication services to users. Offering such services on a fee-collecting, subscriber basis may help increase the revenue of a service provider network. Disclosed embodiments provide subscribers with historical communications that have occurred with a calling party, which can be especially helpful in a call center or help desk environment. This contributes to the working efficiency of users by finding communications, emails, telephone calls, and the like associated with a calling party. A contacting party's incoming telephone number, email address, IM identifiers, and the like are mapped to at least one database and a user is provided automatic access to all prior communications relevant to the contacting party. Some embodiments utilize an enhancement to the ENUM service, in which the enhanced ENUM service enables a service provider to provide converged multimedia communication services to the subscribers. Because ENUM service may be an important component of Internet Protocol Multimedia Subsystem (IMS) networks, disclosed embodiments may have applicability to IMS networks.

On some networks including the Internet, the domain name system (DNS) associates various forms of information with domain names. DNS translates human-readable computer hostnames (e.g., att.com) into the IP addresses that network appliances need for routing and delivering information. DNS may also store data such as a list of mail exchange servers that accept email for a given domain.

E.164 is a standard that defines the international public telecommunication numbering plan that may be used in the public switched telephone network (PSTN) and other service provider networks. E.164 also defines the format of telephone numbers. E.164 numbers may have a maximum number of digits (e.g., 15 digits) and may be written with a “+” prefix. For international dialing, an appropriate international call prefix is typically used.

ENUM is a suite of protocols to map the E.164 telephone numbers to Naming Authority Pointer (NAPTR) records. The mapping is implemented by an ENUM Server 107.

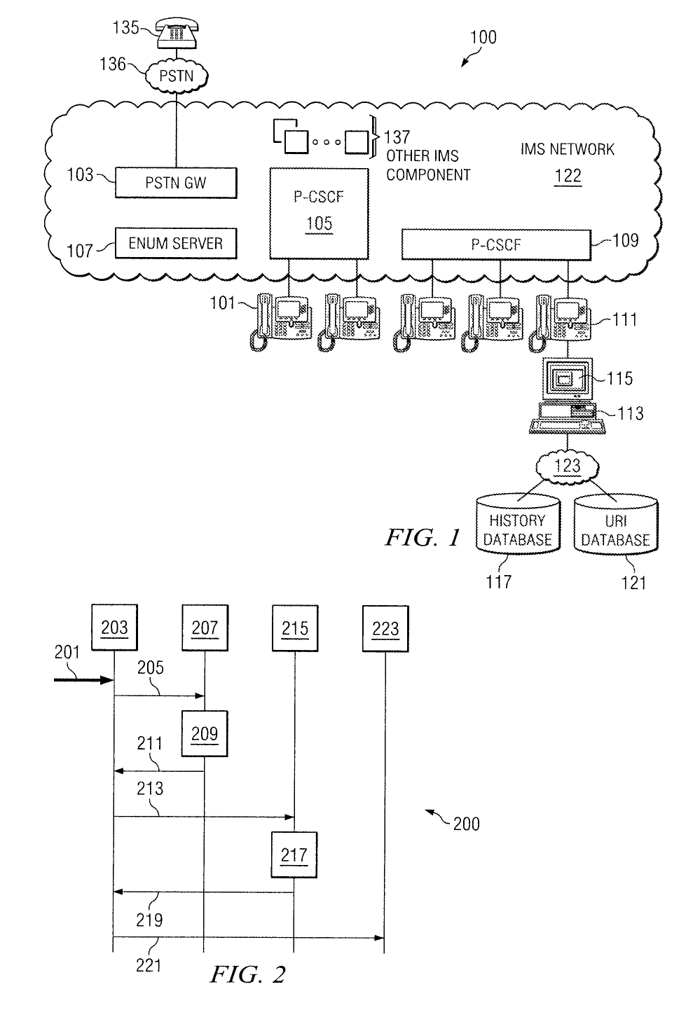

FIG. 1 illustrates network 100 that includes representative hardware components that may operate in accordance with disclosed embodiments. During initiation of a communication session such as a telephone call, identification information regarding the initiator of the communication session may be used to retrieve a communication history associated with the initiator. Although network 100 describes the initiation of a telephone call as the communication session, other service types may be used for the communication session including email, IM chat, and facsimile, as examples. Further, in some embodiments, use of the term communication “session” does not necessarily include establishing a lengthy or dedicated communication pathway or link. Instead, the communication session may consist of a brief transmission and reception of an email or short message service (SMS) text message, as examples.

In an embodiment using network 100 (FIG. 1), telephone 101 is used to dial a telephone number 1-555-372-5485 that is associated with telephone 111. Signals (e.g., caller ID information) associated with the call may be passed to IMS network 122. Alternatively, a call placed from PSTN telephone 135 may be routed through PSTN 136 and signals including caller ID information may be passed to IMS network 122 through PSTN gateway 103. IMS network 122 may be any network for delivering internet protocol (IP) multimedia to users of communication devices including mobile telephones, video telephones, voice over IP (VoIP) telephones, and the like. Upon IMS network 122 receiving signals including caller ID information, ENUM server 107 may be accessed to retrieve a plurality of URIs associated with the initiator of the communication session. Retrieval of the plurality of URIs may be initiated by an application hosted by a server within IMS network 122, for example. Each URI may correspond to an address, locator, or index associated with other communications involving the initiator of a current communication session.

Accordingly, disclosed embodiments may relate to the retrieval of multimedia information collected and correlated from multiple, prior communication sessions. As shown in FIG. 1, a communication session may be a telephone call initiated from telephone 101 that includes or is associated with one or more signals that contain caller ID information related to the initiator or an account associated with telephone 101. Alternatively, as shown in FIG. 1, a telephone call may be initiated by a user of telephone 135 over PSTN network 136. Further, during such a call there may be a signal or signals containing caller ID information associated with telephone 135 or an account that may be linked to telephone 135.

As shown in FIG. 1, proxy call/session control function (P-CSCF) 105 is communicatively coupled to telephone 101 for establishing communication sessions or effecting the delivery of multimedia content through IMS network 122. P-CSCF 105, as shown, may act as a first point of contact for IMS network 122 with telephone 101 or a network (not shown) through which telephone 101 communicates. In some embodiments, caller ID information associated with a communication session initiated by telephone 101 or telephone 135 is converted into an E.164 compliant string, such as “$ORIGIN 5.8.4.5.2.7.3.5.5.5.1.e164.arpa.” This E.164 complaint string or other caller ID information may be used to access URIs that may be hosted or accessed by ENUM server 107. In response to a query using the E.164 string or caller ID information, for example, ENUM server 107 returns all or selected URIs associated with a user or account referenced by the E.164 string.

As shown in FIG. 1, IMS network 122 includes other IMS components 137, which may be for example, other P-CSCFs, an interrogating-CSCF (I-CSCF), a serving-CSCF (S-CSCF), or home subscriber server (HSS), as examples. In addition, IMS components 137 may, for example, include data processing systems deployed as servers such as media servers, DNS servers, and the like. Further, IMS components may include a converged multimedia server (not shown) for accessing ENUM server 107 using an E.164 string version of caller ID information or other identification information provided or accessed during the initiation of a communication session such as a telephone call. Some embodied converged multimedia servers included in IMS components 137 have functionality for collecting data associated with a communication and cross-correlating the data to provide access to the data during subsequent communication sessions. For example, the converged multimedia server may collect and store notes taken by a participant of a telephone conversation conducted using PSTN-connected telephones. Alternatively, the converged multimedia server may collect and store notes taken by a participant of a telephone conversation or communication session between SIP appliances. In addition to storing and correlating the notes, the converged multimedia server may store or caused to be stored identification information associated with the initiator and participants of the communication session. In some embodiments, the communication session has a service type that differs from the service type associated with stored URIs.

Still referring to FIG. 1, in an embodiment, telephone 101 is associated with a customer that is calling into a customer service professional that uses telephone 111. Telephone 111 may have an associated personal computer 113 or other data processing system with a display 115 that presents graphical user interfaces for providing the customer service professional with access to customer account information and similar information associated with the user of telephone 101. The personal computer associated with the customer service professional may operate or access a service application (e.g., one running on a converged multimedia server represented within IMS components 137) that is stored on computer readable medium and is operational to receive identification information associated with telephone 101 and use that information to query ENUM server 107 for multiple URIs associated with the identification information. The multiple URIs may be from different types of services, for example, email, IM chats, SMS text messages, multimedia messaging services (MMS) text messages, telephone calls, faxes, and the like. Upon receiving the identification information, which may be a telephone number or an IM chat address as examples, the service application uses the identification information to access from URI database 121 multiple URIs associated with the identification information. The ENUM database may not include all of the URIs that may be present in the URI database. As shown, service applications running on personal computer 113 may communicate over network 123 with URI database 121 and history database 117. URI database 121 returns multiple URIs to the service application on personal computer 113, with each URI having a common element with the identification information (e.g., caller ID information). Each returned URI has a common element for at least the reason that each is associated with a common user or user account, so that when the user or a person from the user account contacts a subscriber of embodied systems, the subscriber may be provided with all relevant prior communications for the user or user account.

FIG. 2 illustrates a portion of a high level methodology 200 that may be performed when conducting an ENUM DNS database or DNS database query during the set up of a telephone call, for example, between SIP enabled appliances (e.g., telephone 101 and telephone 111 in FIG. 1). IMS node 203, which in an embodiment is an S-CSCF, receives SIP request 201. In query operation 205, IMS node 203 queries ENUM server 207 using a reverse-number E.164 compliant string that may be generated from information provided in SIP request 201. ENUM server 207 may be identical to or similar to ENUM server 107 (FIG. 1). In search operation 209, ENUM server 207 searches tables for a list of SIP URIs associated with the E.164 compliant string provided in query operation 205. In result operation 211, ENUM server 207 provides IMS node 203 with one or more SIP URIs found in search operation 209. In query operation 213, IMS node 203 requests from DNS 215 any relevant IP addresses of the SIP URIs. In result operation 219, DNS 215 provides IP addresses obtained in search operation 217, which is performed in response to query operation 213. In request operation 221, IMS node 203 submits an SIP request to IMS node 223, which in an embodiment is an I-CSCF.

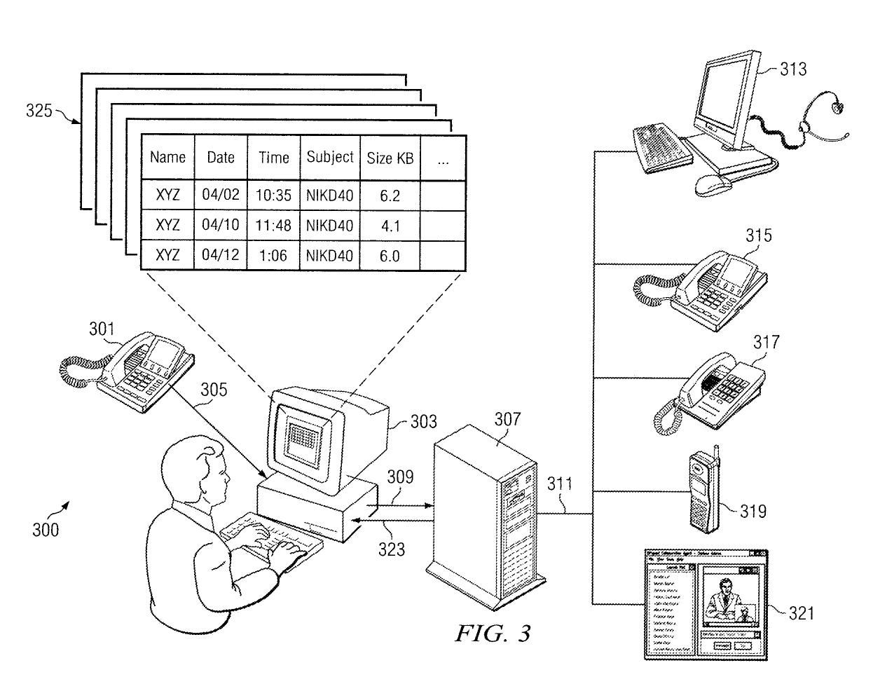

FIG. 3 illustrates aspects of an embodied method 300. As shown, telephone 301 initiates communication with personal computer (PC) client 303 and identification information 305 is received by PC client 303. The user of PC client 303 may be, for example, a call center support person receiving inquiries from customers. The identification information 305 may include, for example, the telephone number and a user name associated with telephone 301. As shown, PC client 303 queries ENUM server 307 and ENUM server 307 conducts mapping using data based on identification information 305. ENUM server 307 may access data stored in one or more databases, wherein the data includes multiple URIs associated with different service types (e.g., standard telephone, email, IM chat, SMS text, IMS phone address, and mobile telephone address). As shown, ENUM server 307 accesses data 311, which may include email address 313, device network phone address 315, PSTN phone address 317, mobile telephone address 319, and IM contact address 321. PC client 303 as shown receives data 323 from ENUM server 307, with data 323 including data 311. PC client 303 includes a display for presenting database data 325, which may include selectable text or selectable icons for accessing prior communications corresponding to identification information 305. Data 325 may contain actual transcripts or summaries of prior communications including IM chat sessions and emails, multimedia voice and/or video recordings, or may contain operator notes taken regarding multiple telephone conversations or other communications. In some embodiments, PC client 303 uses data 323 to retrieve communication history from different servers including email servers, IM servers, and telephone servers. The communication history may have different service types, such as email, IM chat, and telephone records. Commands for obtaining the communication history by the user of PC client 303 may be incorporated into Application Programming Interfaces (API) associated with PC client 303, for example. Also, as shown, database data 325 may contain the size (e.g., 6.2 kB) of electronic files associated with one or more entries.

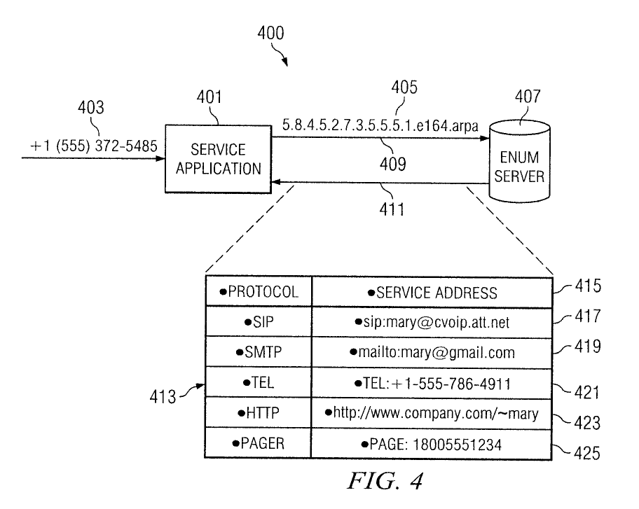

FIG. 4 illustrates scheme 400 for obtaining a plurality of URIs that are based on identification information associated with an incoming communication. In scheme 400, the incoming communication is a telephone call having an associated telephone number 403. Service application 401 translates telephone number 403 into URI 405, which as shown is an E.164 compliant identifier. In function 409, service application 401 sends URI 405 to ENUM server 407, and ENUM server 407 returns data 413, which includes a plurality of URIs. Data 413 includes protocol entry 415 which includes a service address. As shown, entry 417 includes an SIP identifier and entry 419 includes an SMTP address. Entry 421 includes a telephone number, which as shown is different from the telephone number used in mapping or accessing data 413. The identification number used to access data 413 is a telephone number, but data 413 may include other telephone numbers. For example, an entry may be associated with a person with a home telephone number, a business telephone number, a fax number, and a mobile telephone number. As shown, data 413 includes HTTP entry 423, which includes a website address or web based URL associated with the user that initiates the call that results in telephone number 403 being received by service application 401. Entry 425 includes a pager number as an additional URI included with data 413. The illustrative protocol types are shown for legibility and are not meant to be syntactically precise or limiting in any form. Further, embodied systems may not use all of the records shown in FIG. 4. For example, some embodiments may not use HTTP entry 423 or pager record 425.

URI 405 results from the translation of telephone number 403 by service application 401. Service application 401 then requests from ENUM server 407 a plurality of URIs that are included with data 413. Each URI entry 415, 417, 419, 421, 423, 425 within data 413 has a service type that may be an SIP identifier, email identifier, telephone number, IM chat address, a web identifier, or URL, as examples. As shown, telephone number 403 is “+1-555-372-5485.” Service application 401 translates telephone number 403 into URI 405, which results in “5.8.4.5.2.7.3.5.5.5.1.e164.arpa,” in accordance with E.164 protocols and standards. ENUM server 407 processes and maps URI 405 to result in data 413, which contains multiple URIs, with some having differing service types (e.g., SMTP, SIP, POTS, HTTP) compared to others.

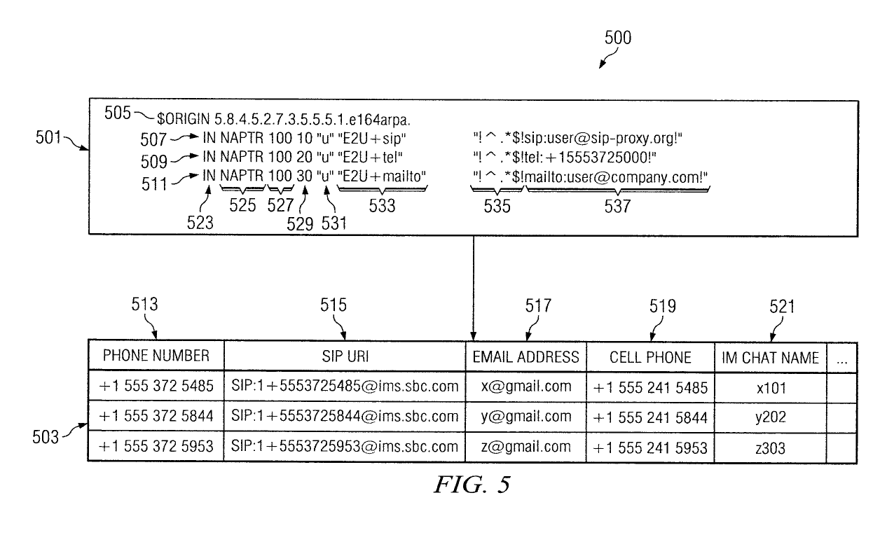

FIG. 5 shows a representation 500 of relational database portion 503 and ENUM NAPTR record 501. ENUM NAPTR record 501, as shown, is formatted similarly to NAPTR standards. ENUM queries may be indexed based on an incoming telephone number, which is represented by URI 505. Telephone number field 513 is obtained by translating a telephone number 1-555-372-5485 into E.164 format. ENUM NAPTR record 501 includes record 507, and like ENUM record 509 and ENUM record 511, has a query type 525 of “NAPTR,” a query class 523 of “IN,” an order 527 of “100,” and a flag 531 of “u.” Field 529 provides a preference variable for categorizing the URIs. As shown, record 507 includes a resolution service entry 533 equal of “E2U+sip.” Similarly, record 509 has resolution service entry 533 of “E2U+tel” and, likewise, record 511 has resolution service entry 533 of “E2U+mailto.” As shown, records 507, 509, and 511 each include resource record 537 that may be used for resolution of DNS records. Record 507 includes the expression “sip:user@sip-proxy.org!,” which is used in ENUM database resolution for SIP-based entries. As shown, each record 507, 509, and 511, includes the expression “!̂.*$” in which the “!” acts as a delimiter.

In accordance with disclosed embodiments, ENUM NAPTR record 501 is converted to the relational database portion 503. When searching records, an index key may be any one of several data fields including telephone number field 513, SIP URI field 515, email address field 517, mobile telephone number field 519, or IM chat address field 521. In this way, an incoming communication can be used to retrieve prior contact records, which may include all prior communications or those prior communications that have been marked as important. An incoming communication contains identification information such as URI 505 that contains information used to index relational database portion 503 to obtain relevant records.

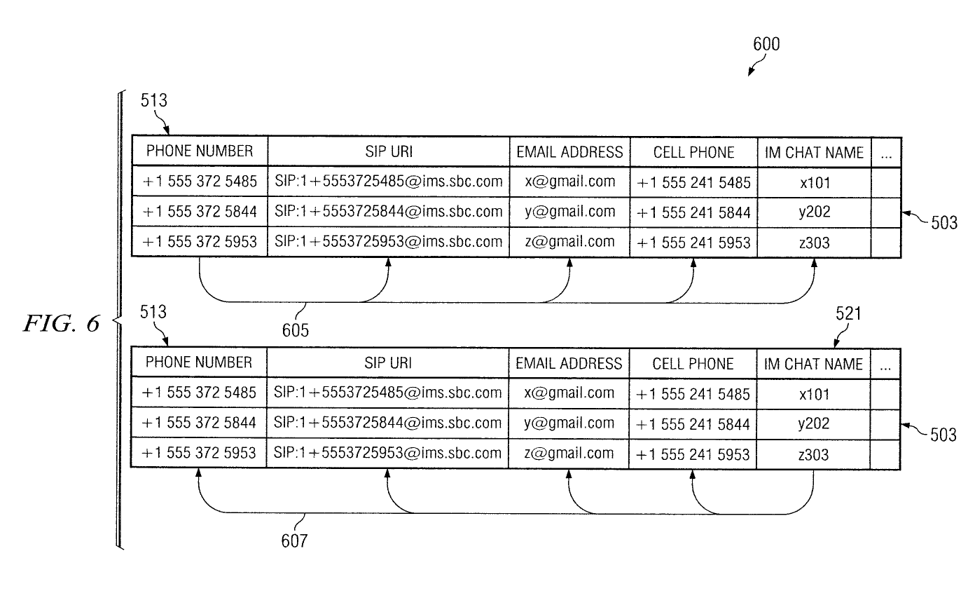

As shown in FIG. 6, representation 600 illustrates relational database portion 503 is indexed using telephone number field 513. As shown, in operation 605, the relational database portion 503 is accessed to obtain a SIP URI, an email address, a mobile telephone number, and an IM chat address that corresponds to the identification information for an incoming telephone call. The information gathered in operation 605 may then be utilized by a client application, for example, in accessing one or more databases that store records associated with telephone calls, email correspondence, mobile telephone calls, IM chats, and the like. Also as shown in FIG. 6, a chat name may be used to retrieve other contact records. As shown, relational database portion 503 is searched during operation 607 based on other addresses such as the sample IM chat address field 521. When an incoming IM chat is received, it contains identification information in the form of an IM chat address. This identification information is utilized in accessing multiple other URIs associated with a user or account corresponding to the identification information. Using the accessed URIs, an embodied system may access one or more databases that store communication histories. For example, a URI accessed from a mobile telephone field 519 (FIG. 5) may be used in accessing one or more databases having telephone transcripts, operator notes, or other data associated with all prior communications received by a service provider or multiple service providers. In this way, a service provider may store information associated with a customer, for example, and upon receiving a call from the customer, the service provider is provided with prior communications from multiple service types including email, IM chats, and telephone calls. Conceivably, a customer may be provided with better service if an operator or customer assistant has relevant information readily available. By providing information to an operator or customer assistant that is obtained from multiple service types, it is possible to improve customer service. Embodiments also may serve a security function, by allowing a customer assistant to verify with a caller details regarding prior communications, which may have been telephone calls, IM chats, or mobile telephone calls.

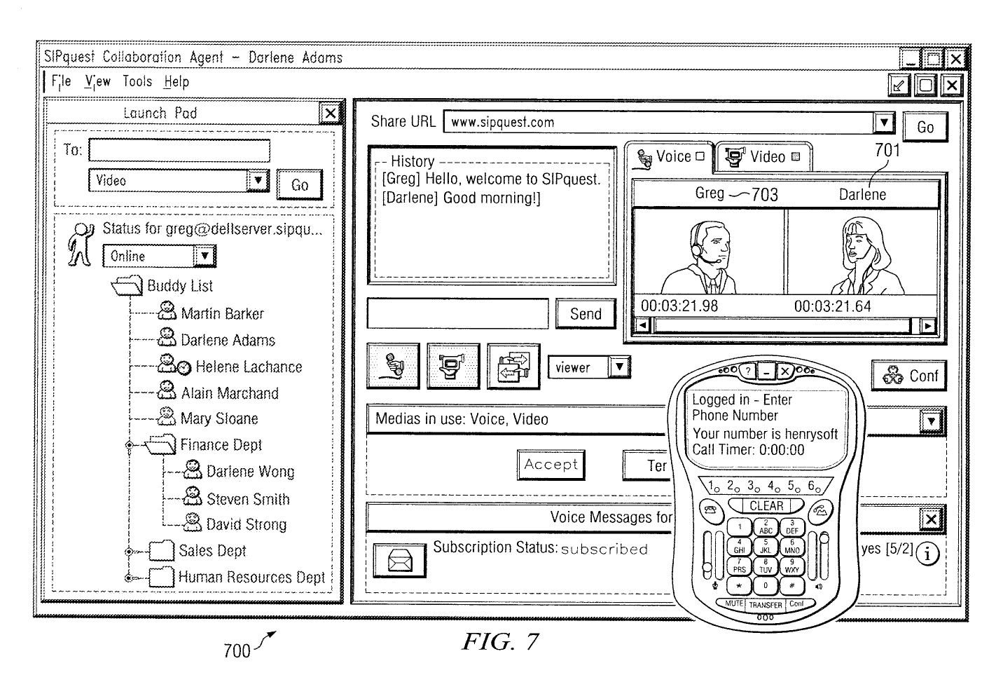

FIG. 7 shows a graphical user interface 700 for an embodied system. In operation, a helpdesk professional 701 receives a call from a customer 703. The helpdesk professional may work in a corporate call center, for example, and receive calls throughout the day from customers having various needs. If customer 703 uses a telephone to call into the corporate call center, identification information in the form of caller ID may be captured by helpdesk professional 701's embodied client application (e.g., PC agent). Customer 703's telephone number may serve as a trigger for sending an ENUM query to an ENUM server. Upon one or more matches in the ENUM database, customer 703's service addresses are provided to the embodied client application running on helpdesk professional 701's personal computer. In some embodiments, the service addresses include multiple URIs associated with different service types such as email and IM chats. Having accessed the multiple URIs, the embodied client application may then communicate with other software clients (for example, email client, IM client, phone mail client) via standard APIs and present all historical communication with customer 703 to graphical user interface 700. In the event customer 703 is a first-time caller (or communicator using other service types such as IM chats), an embodied client application may be provisioned for setting up database entries for the customer for later retrieval during subsequent communications. In other cases, when a new service type is used for an existing contact, new contact information for that service type is stored. Graphical user interface 700 provides a means for presenting converged multimedia communication services to helpdesk professionals and other subscribers. Such a system of providing enhanced information received using various service types promotes productivity and customer satisfaction.

Using disclosed embodiments, customer relationship management (CRM) inconsistencies in call center or help desk environments may be reduced because call logs and communication histories for a customer are presented to a support personnel's desktop. In other environments, worker productivity may be increased using disclosed embodiments. For example, in an enterprise environment, one may communicate with many co-workers via different methods (i.e., service types) including phone, email, IM, and the like. If two parties have an email thread going back a few weeks ago and one party calls the other to discuss the email thread, it may be useful for the receiving and calling parties' email client to easily access all recent emails and other communication history. In some cases, a party receiving a call may be presented with the communication history even before a call is answered, with the data accessed rapidly and automatically while the telephone is ringing or during set up of an SIP communication session between SIP enabled appliances.

The 3rd Generation Partnership Project (3GPP) is associated with a set of mobile telephone system specifications. 3GPP specifications are related to Global System for Mobile Communications (GSM) specifications and may incorporate GSM specifications. Disclosed embodiments are intended to be compatible with these standards and should be compatible with similar future standards.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
receiving an originating communication, wherein the originating communication includes identification data;
querying a database for multiple uniform resource identifiers (URIs),
wherein each URI has an element associated with the identification data,
wherein each URI is associated with at least one service type chosen from a plurality of service types, and
receiving one or more records corresponding to each URI.

2. The method of claim 1, wherein at least one of the plurality of service types is a telephone number.

3. The method of claim 1, wherein at least one of the plurality of service types is an email.

4. The method of claim 1, wherein at least one of the plurality of service types is a mobile telephone address.

5. The method of claim 1, wherein at least one of the plurality of service types is a session initiation protocol telephone address.

6. The method of claim 1, wherein at least one of the plurality of service types is an instant message (IM) contact address.

7. The method of claim 1, wherein the database is a Telephone Number Mapping database.

8. The method of claim 2, wherein the identification data includes a telephone number, the method further comprising:
converting the telephone number into an E.164 address.

9. The method of claim 8, wherein the identification data includes an email address.

10. The method of claim 1, wherein the identification data includes an IM chat name.

11. The method of claim 1, further comprising:
presenting a graphical user interface including selectable icons for accessing data from each of the one or more records corresponding to each URI.

12. A data processing system including a client application stored on a computer readable medium, the client application having instructions operable for:
receiving identification data associated with an incoming communication;
receiving a first uniform resource identifier (URI) corresponding to the identification data;
receiving a second URI corresponding to the identification data,
wherein the first URI has a first service type,
wherein the second URI has a second service type,
wherein the first service type is different than the second service type;
receiving a first communication history for the first URI; and
receiving a second communication history for the second URI.

13. The data processing system of claim 12, wherein the incoming communication is an instant message (IM) chat message.

14. The data processing system of claim 12, wherein the incoming communication is an email.

15. The data processing system of claim 12, wherein the incoming communication is a telephone call.

16. The data processing system of claim 12, wherein the incoming communication is an SMS text message.

17. The data processing system of claim 15, wherein the first service type is telephone service.

18. The data processing system of claim 16, wherein the second service type is IM chat service.

19. A service for providing a communication history related to a contacting party, the service comprising:
receiving identification data from a communication received from the contacting party;
accessing multiple uniform resource identifiers (URIs), wherein at least one of the multiple URIs corresponds to the identification data; and
accessing a saved communication corresponding to each of the accessed URIs,
wherein a first service type associated with a first saved communication differs from a second service type of another of the saved communications.

20. The service of claim 19, wherein the first service type is email service.

21. The service of claim 19, wherein the second service type is telephone service.

22. The service of claim 19, wherein the communication received from the contacting party is an instant message (IM) chat message, wherein the identification data is an IM chat address.

23. The service of claim 19, wherein the communication received from the contacting party is a telephone call, wherein the identification data is caller ID information.
